(19) United States
(12) Patent Application Publication
(10) Pub. No.: US 2005/0023306 A1
(43) Pub. Date: Feb. 3, 2005

(54) Closeable dispensing device for dispensing a liquid, viscous or pasty medium contained in a container

(75) Inventor: Werner Patz, Hofstetten (DE)

Correspondence Address: LERNER AND GREENBERG, PA, P O BOX 2480, HOLLYWOOD, FL, 33022-2480, US

(73) Assignee: BMF GmbH

(21) Appl. No.: 10/889,864

(22) Filed: Jul. 12, 2004

Related U.S. Application Data
(63) Continuation of application No. PCT/DE02/04626, filed on Dec. 18, 2002.

(30) Foreign Application Priority Data
Jan. 10, 2002 (DE) 102 00 748.9

(51) Int. Cl. B67D 5/33

(52) U.S. Cl. 222/545; 222/554

(57) ABSTRACT

A closeable discharger for discharging a liquid, viscous or pasty material contained in a container, has an outlet used to discharge the medium, a channel extending between the container and the outlet, and a closing device which is used to close the channel. The discharger is characterized in that the closing device is formed by a rotatable part with an axis of rotation extending across the channel. The discharger is easy and simple to use but cannot open automatically, irrespective of the circumstances.

### CROSS-REFERENCE TO RELATED APPLICATION

This application is a continuation, under 35 U.S.C. § 120, of copending international application No. PCT/DE02/04626, filed Dec. 18, 2002, which designated the United States; this application also claims the priority, under 35 U.S.C. § 119, of German patent application No. 102 00 748.9, filed Jan. 10, 2002; the prior applications are herewith incorporated by reference in their entirety.

### BACKGROUND OF THE INVENTION

Field of the Invention

The present invention relates to a closeable dispensing device for dispensing a liquid, viscous or pasty medium contained in a container. The device has an outlet that serves for dispensing the medium, a channel that extends between a container and the outlet opening, and a closure device for closing the channel.

Such dispensing devices are used, for example, on drink bottles for children or cyclists.

A dispensing device of this type is described in Published, Non-Prosecuted German Patent Application DE 199 37 754 A1. The dispensing device described in the aforementioned document is a device which can be positioned on a drink bottle and contains a part which, once positioned on the drink bottle, is fixed and a nipple which can be moved relative to the part, or more precisely can be pushed into it and drawn out of it. The nipple has a channel running through it, via which the drink bottle is connected to a drinking opening provided at the top end of the nipple. The channel is closed in the state in which the nipple has been pushed into the fixed part (pushed on to a stopper closing the channel) and is open in the drawn-out state. The dispensing device also contains measures which are intended to ensure that the channel is completely closed in the closed position of the nipple, and that the nipple cannot leave the closed position of its own accord but. On the other hand, it is desirable that the dispensing device can be moved into and out of the closed position with only a small amount of force being applied. These measures are embodied by latching elements which are provided on the nipple and, in the closed position, latch into associated latching elements of the fixed part. The latching elements which are provided on the fixed part of the dispensing device are disposed on elastically movable elements which are accessible from outside the dispensing device.

The fact that the dispensing device can be closed in a sealed manner, and cannot open of its own accord, is an important precondition in allowing the drink bottle also to be used for carbonated beverages. In the case of dispensing devices which do not satisfy the above-mentioned requirements, the positive pressure produced in the drink bottle by carbon dioxide can cause the dispensing device to open of its own accord, which may result in the beverage located in the drink bottle running out, and in gases flowing out (a reduction in the carbon-dioxide content of the beverage). It goes without saying that both of these occurrences are undesirable.

The measures which have been taken in order to satisfy the above-mentioned conditions in the case of the above-described dispensing device known from Published, Non-Prosecuted German Patent Application DE 199 37 754 A1 do not optimally satisfy these conditions. It cannot reliably be ensured that the dispensing device does not open of its own accord and, furthermore, the dispensing device is more complicated to use (the operations of closing and, in particular, opening the dispensing device).

### SUMMARY OF THE INVENTION

It is accordingly an object of the invention to provide a closeable dispensing device for dispensing a liquid, viscous or pasty medium contained in a container that overcomes the above-mentioned disadvantages of the prior art devices of this general type, which is easier and more straightforward to use, and cannot under any circumstances open of its own accord.

With the foregoing and other objects in view there is provided, in accordance with the invention, a closeable dispensing device for dispensing a medium such as liquid mediums, viscous mediums and/or pasty mediums contained in a container. The closeable dispensing device contains a body having an outlet opening formed therein for dispensing the medium, a channel formed therein extending between the container and the outlet opening, and a closure device for closing the channel. The closure device has a rotatable part with an axis of rotation running transversely to the channel.

The dispensing device according to the invention is distinguished in that the closure device is formed by a rotatable part with an axis of rotation running transversely to the channel.

The use of such a closure device proves to be advantageous because a positive pressure or negative pressure prevailing in the container cannot give rise to any forces which act in or counter to the direction in which the closure device has to be moved in order to pass from the open position into the closed position or vice versa. As a result of which the situation where the closure device is moved of its own accord by a positive pressure or negative pressure prevailing in the container is ruled out, and the closure device can be moved from the open position into the closed position or vice versa, under all circumstances, with only a small amount of force being applied.

Such a closure device makes it possible, in an extremely straightforward manner, to achieve the situation where the dispensing device can be used easily and straightforwardly and nevertheless does not, under any circumstances, open of its own accord.

Other features which are considered as characteristic for the invention are set forth in the appended claims.

Although the invention is illustrated and described herein as embodied in a closeable dispensing device for dispensing a liquid, viscous or pasty medium contained in a container, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a dispensing device described herein below, with a closure device located in a closed position, and taken along a section line I-I depicted in FIG. 2;

FIG. 2 is a diagrammatic, sectional view of the configuration shown in FIG. 1 taken along a section line II-II depicted in FIG. 1;

FIG. 3 is a diagrammatic, sectional view of the dispensing device, with the closure device located in the open position and taken along a section line III-III depicted in FIG. 4; and

FIG. 4 is a diagrammatic, sectional view of the configuration shown in FIG. 3 and taken along a section line IV-IV depicted in FIG. 3.

### DESCRIPTION OF THE PREFERRED EMBODIMENTS

A dispensing device described herein below is configured for use on a drink bottle; a liquid (a beverage) contained in the drink bottle can be poured out or drunk via the dispensing device.

It should be pointed out at this juncture, however, that the dispensing device described herein below is not restricted to such a use. It is also possible for the dispensing device—if appropriate following corresponding adaptation to the given conditions—to be used for containers other than a drink bottle, and for then to dispense difference liquid, viscous or pasty media, for example medicaments, soaps, oils, perfumes, detergents, etc.

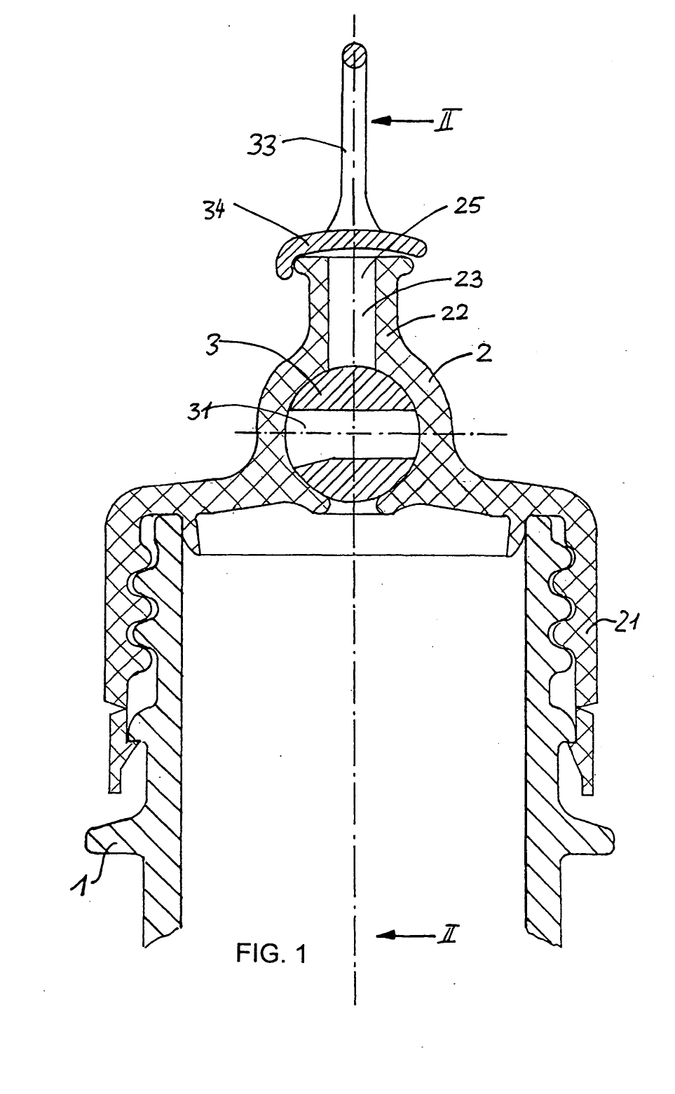

Referring now to the figures of the drawing in detail and first, particularly, to FIG. 1 thereof, there is shown a dispensing device screwed onto a neck 1 of a bottle. It is not absolutely necessary, however, for the dispensing device to be fastened on the neck 1 by being screwed on to the same. It is also possible for fastening to take place in any other desired manner, for example by plugging on, plugging in, screwing in, adhesive bonding, etc.

The dispensing device in question here contains a spout part 2 which is fixed (in the state in which the dispensing device has been fastened on the neck 1 of the bottle), and a closure device 3 which is plugged into the spout part 2 and can be moved relative to the spout part 2.

The spout part 2 contains a fastening portion 21, for fastening the spout part 2 on the neck 1 of the bottle, and a spout 22 with an outlet opening 25 provided at the top end of the same. The liquid contained in the bottle is dispensed via the outlet opening 25 when the dispensing device is open. In the example in question, the shape and the size of the spout 22 are selected such that an individual can insert the spout 22 into his/her mouth and drink therefrom. The spout 22 can basically be of any desired shape and any desired size; the shape and the size of the spout 22 are preferably made dependent on the intended use of the dispensing device.

In the bottom region, the spout 22 has a cutout which runs transversely to the neck 1 of the bottle and into which the closure device 3 can be plugged. The cutout has a top and bottom opening in each case, via which it can be connected to the bottle interior (bottom opening) and to the outlet opening 25 (top opening).

The spout 22 also has a channel, which is referred to herein below as channel part 23 and extends, in a longitudinal direction of the spout 22, between the outlet opening 25 and the cutout which serves for accommodating the closure device 3.

The closure device 3 is formed by a cylindrical element and is plugged into the already mentioned cutout of the spout 22 and, within the cutout, can be rotated about the longitudinal axis of the closure device 3 relative to the spout part 2.

The closure device 3 has a channel running through it, this channel runs transversely to the longitudinal axis of the closure device 3 and is referred to herein below as a channel part 31.

The shape and the size of the closure device 3 and of the cutout of the spout 22 which accommodates the closure device 3 are adapted to one another, i. e. the cutout of the spout 22 is also of cylindrical configuration, and the external diameter of the closure device 3 and the internal diameter of the cutout which accommodates the closure device 3 are of equal size, with the result that there are no interspaces between the closure device 3 and the cutout through which liquids or gases can pass.

It may prove advantageous here if that part of the spout 22 which is located between the closure device 3 and the bottle interior, that is to say the bottom region of the cutout which accommodates the closure device 3, is of an elastic construction, at least in part, and can be pressed elastically against the closure device 3 by a positive pressure prevailing in the container.

As an alternative, or in addition, provision may be made for the cross section of the closure device 3 and the cutout of the spout 22 which accommodates the closure device 3 to be of slightly elliptical configuration. The components are constructed such that the longitudinal axis of the elliptical cross section of the cutout of the spout 22 runs transversely (preferably at right angles) to the course taken by the channel part 23, and that the longitudinal axis of the elliptical cross section of the closure device 3 in the position of the closure device 3 in which the latter closes the channel part 23, runs transversely (preferably at right angles) to the longitudinal axis of the elliptical cross section of the cutout of the spout 22, and in that position of the closure device 3 in which the latter does not close the channel part 23, coincides with the longitudinal axis of the elliptical cross section of the cutout of the spout 22.

As a result, in that position of the closure device 3 in which the latter closes the channel part 23, there is a clamping action between the closure device 3 and the cutout of the spout 22 which accommodates the closure device 3, and the channel part 23 is closed particularly tightly. The same applies to the elastic configuration of the dispensing-device elements located between the closure device 3 and the bottle interior.

For the sake of completeness, it should be pointed out that such an elliptical configuration of the closure device and of the cutout that accommodates the latter also proves to be advantageous for other dispensing devices which have the rotatable closure device 3.

Interengaging guide elements are preferably provided on the spout part 2 and on the closure device 3, these guide elements prevent unintended removal of the closure device 3 from the spout part 2 at least in the closed state of the dispensing device.

As has already been mentioned above, the closure device 3 can be rotated about its longitudinal axis. By virtue of the closure device 3 being rotated about its longitudinal axis, the channel part 31 contained in it is also rotated.

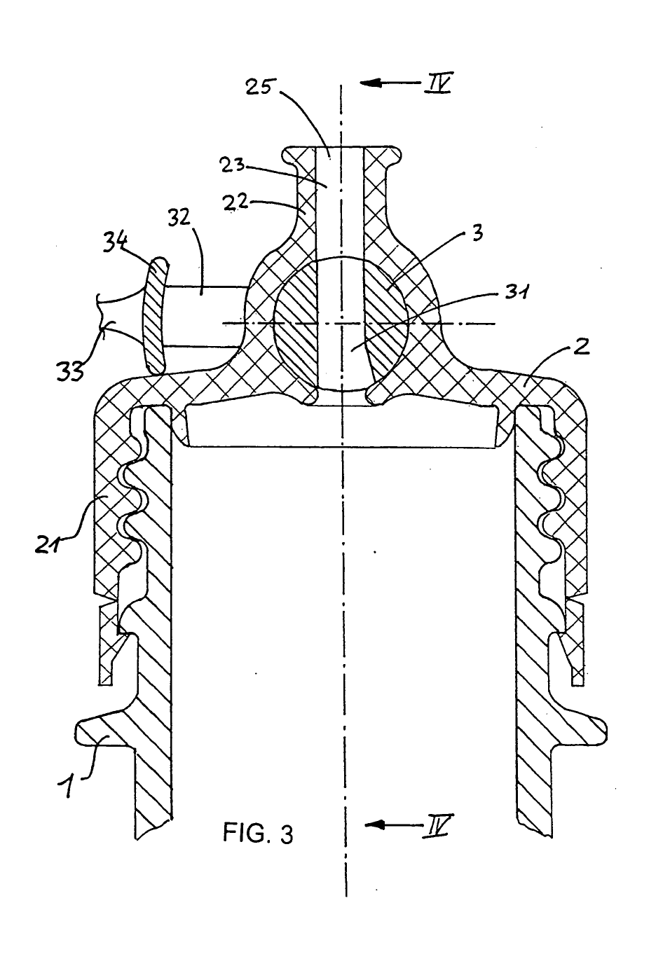

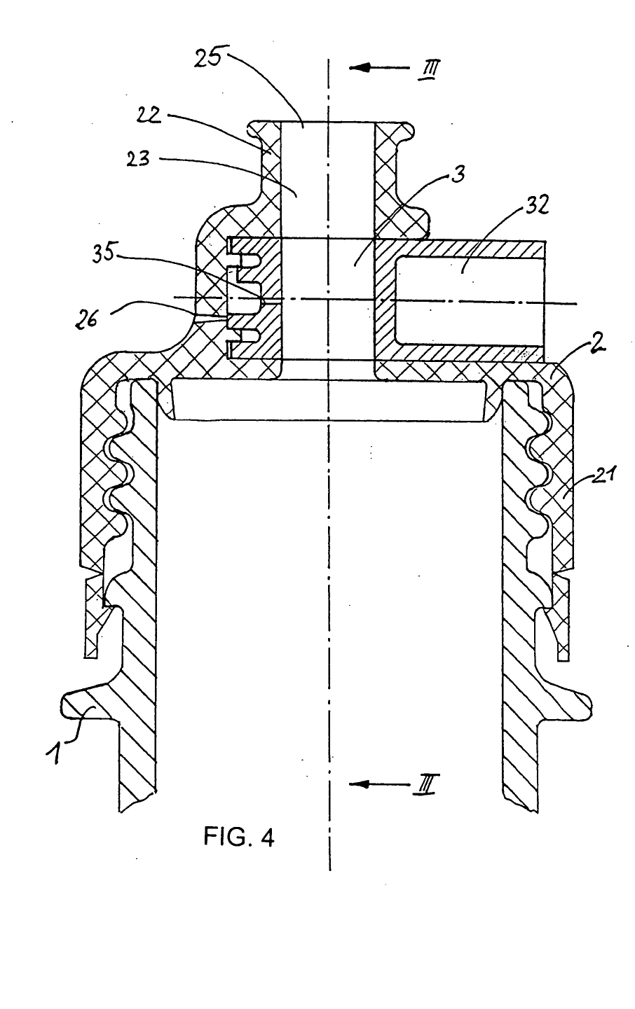

In order for it to be possible for the liquid contained in the bottle to reach the outlet opening 25, the channel parts 23 and 31 have to be aligned with one another. Alignment of the channel parts 23 and 31 with one another results in a through-channel between the bottle interior and the outlet opening 25, it being possible for the liquid contained in the bottle to reach the outlet opening 25 via the through-channel. This state of the dispensing device is illustrated in FIGS. 3 and 4.

If the closure device 3 is rotated about its longitudinal axis starting from the position that is shown in FIGS. 3 and 4, the channel parts 23 and 31 are rotated in relation to one another. The region of overlap of the channel parts 23 and 31 becomes constantly smaller and, finally, the channel part 21 and the channel part 31 no longer overlap at all, as a result of which there is no longer any through-channel from the bottle interior to the outlet opening 25 and, consequently, it is no longer possible for any liquid to reach the outlet opening 25 from the bottle.

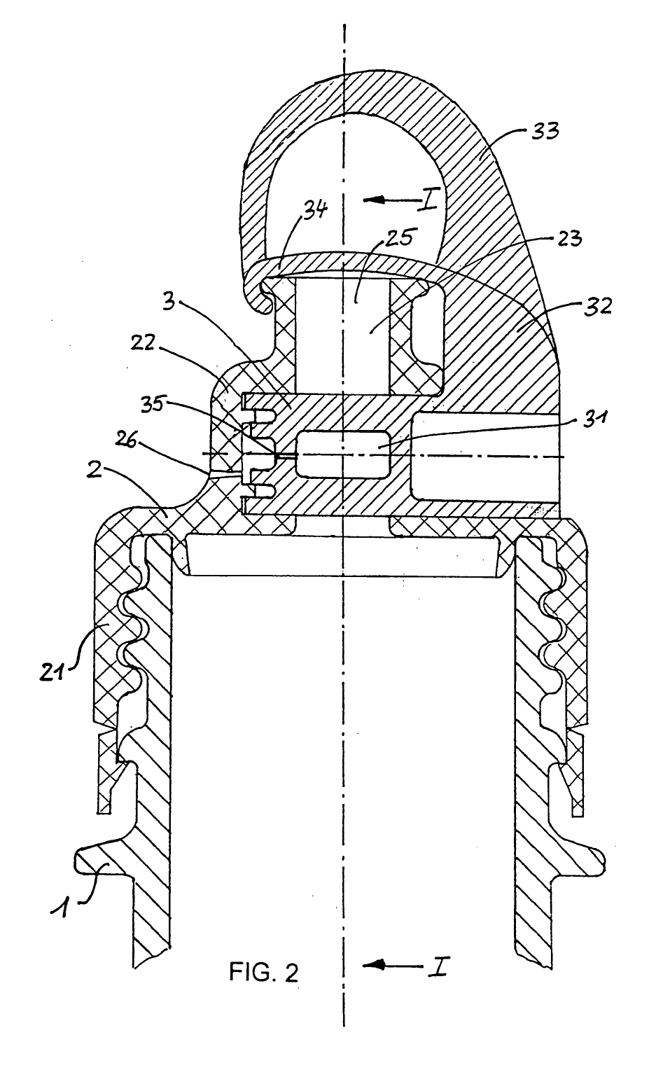

In the state that is shown in FIGS. 1 and 2, the closure device 3 has been moved all the way into the closed position, and the bottle is closed in a liquid-tight and gas-tight manner.

In order to open the dispensing device, the closure device 3 is rotated in the same direction as for closing the dispensing device or in the opposite direction. The channel parts 23 and 31 thus end up coinciding again, and the state that is shown in FIGS. 3 and 4 is reached again.

The rotation of the closure device 3 can be carried out with only a very small amount of force being applied even when a positive pressure or a negative pressure is prevailing in the bottle. This is due to the fact that the force to which the closure device 3 is subjected by a positive pressure or a negative pressure prevailing in the bottle does not act in the direction in which the closure device 3 has to be moved in order for the latter to be moved from the closed position into the open position and vice versa.

The closure device 3 can be moved even more easily than is already the case if one or both of the measures described herein below are taken.

The first of the abovementioned measures consists in a lever 32 being provided laterally on the closure device 3, the lever 32 extending perpendicularly from the closure device 3, and more precisely perpendicularly to the axis of rotation of the closure device 3. With the aid of the lever 32, the closure device 3 can be rotated even more easily than is already the case.

As can be seen from FIGS. 1 and 3 in particular, the lever 32 projects upward in the closed state of the dispensing device and to the side in the open state of the dispensing device. This is not restricted in any way, however.

In the example in question, the free end of the lever 32 is configured as a hanging device, for example as a ring 33. It is thus possible for the bottle which exhibits the dispensing device described to be hung on other articles, for example on a rucksack.

In the example in question, a closure cap 34, is provided on the lever 32, the closure cap 34, in the closed state of the dispensing device, ending up located automatically above the outlet opening 25 and protecting the latter against contamination.

The closure cap 34 is a disk-shaped element which is provided, at one or more locations of the underside of the same, with angled elements which, in the state in which the closure cap is moved over the outlet opening 25, engage behind a peripheral bead provided the outlet opening 25 and thus ensure that the closure cap 34 is arrested on the outlet opening 25. For the sake of completeness, it should be mentioned that it is not absolutely necessary to provide the lever 32, the ring 33 provided thereon and the closure cap 34 provided thereon.

The second of the abovementioned measures for facilitating the movement of the closure device 3 consists in ensuring that a positive pressure or negative pressure prevailing in the bottle can dissipate during the movement of the closure device 3, or more precisely prior to the point in time at which the channel parts 23 and 31 begin to overlap. Once a positive pressure or negative pressure prevailing in the bottle has dissipated, the closure device can be moved even more easily than is already the case.

Such pressure equalization can be brought about, for example, in that the shape and/or the position of that end of the channel part 23 which is directed toward the channel part 31, and/or the shape and/or the position of the ends of the channel part 31, and/or the shape and/or the position of the opening of the spout part 2 via which that end of the channel part 31 which is directed toward the bottle ends up located in the open position, are such that, when the closure device 3 is moved into the open position, that end of the channel part 31 which is directed toward the bottle reaches the opening of the spout part 2 leading to the bottle interior at an earlier stage than that end of the channel part 31 which is directed toward the channel 23 reaches the channel 23. In addition, both the spout part 2 and the closure device 3 have respective pressure-equalizing openings 26 and 35 which are connected to one another at least when the channel part 31 is connected to the bottle interior but not yet to the channel part 23.

At a point in time at which the dispensing device is not yet located in the state in which it allows liquid to be removed, it is then possible for pressure equalization to take place between the bottle interior and the atmosphere surrounding the bottle. The point in time at which the pressure equalization is begun can be defined as desired.

The pressure-equalizing openings 26 and 35 are preferably small enough for only a negligibly small amount of liquid, if any at all, to pass or spray out through them.

Such pressure equalization has the positive effect of it not being possible for any forces which are brought about by positive pressure or negative pressure to act on the closure device 3. The closure device 3 can thus be actuated even more easily following the pressure equalization than is already the case.

The example in question is such that the pressure-equalizing openings 26 and 35 are also connected to one another when the dispensing device is located in the state in which it allows liquid to be removed. This is advantageous because pressure equalization can take place even when one is drinking from the bottle, as a result of which drinking is interrupted less often, if at all, on account of the negative pressure produced in the bottle. If the pressure-equalizing openings 26 and 35 are sufficiently small, it is not possible for any liquid to escape through them. Nevertheless, provision could be made for at least one of the pressure-equalizing openings 26 and 35 to be wholly or partially closed when the dispensing device is located in the state in which it allows liquid to be removed. This may be done, for example, in that the pressure-equalizing opening 26 of the spout part 2 is disposed in a region of the spout part 2 which is in constant contact with the closure device 3, and in that the pressure-equalizing opening 35 of the closure device 3 is disposed in a region of the closure device 3 which is in constant contact with the spout part 2, and in that the pressure-equalizing openings 26 and 35, furthermore, are arranged such that they end up located one above the other in those phases in which pressure equalization is desired. It is thus possible to define precisely, by virtue of the construction of the dispensing device, the points in time at which the pressure equalization is to be begun and at which the pressure equalization is to be ended.

In the closed state of the dispensing device, i.e. in that state of the dispensing device which is shown in FIGS. 1 and 2, pressure equalization should not be possible at all.

As will be better understood later, the pressure-equalizing opening 26 of the spout part 2 is preferably located at a location remote from the spout 22, for example laterally in the bottom region of the spout part 2.

Pressure equalization taking place in the manner described or in a similar manner, in addition to facilitating the actuation of the closure device, also has the now described advantages. First, it can thus prevent the situation where, when the dispensing device is opened, liquid sprays out of the spout 25 on account of a positive pressure prevailing in the bottle. Second, it can avoid the situation where an individual who is opening the dispensing device using his/her mouth, or who positions the outlet opening in his/her mouth as the dispensing device is being opened, can, or has to, breathe in gases which pass out of the pressure-equalizing opening as the container is vented.

In respect of this last point, it should be mentioned, in addition, that the act of breathing in the gases that pass out of the bottle, in particular when a carbon-dioxide-containing beverage is located in the bottle, is not without its problems. This is because the gas which passes out here is carbon dioxide, and breathing the latter in could result in the individual who wants to drink from the bottle suffering from a lack of oxygen and the associated side effects. For the sake of completeness, it should also be mentioned in this respect that the act of breathing in the gases which pass out of the bottle interior is prevented in that venting takes place not via the spout 25, but via the pressure-equalizing opening 26 provided at a different location.

Pressure equalization taking place in the manner described or in a similar manner, in addition to proving advantageous for the above described dispensing device, can also be used advantageously for any other desired dispensing devices.

Accordingly, the dispensing device described appears to be advantageous in many respects. It can be used, in particular, easily and straightforwardly and cannot under any circumstances open of its own accord.

1. A closeable dispensing device for dispensing a medium selected from the group of liquid mediums, viscous mediums and pasty mediums contained in a container, the closeable dispensing device comprising:
a body having:
an outlet opening formed therein for dispensing the medium;
a channel formed therein extending between the container and said outlet opening; and
a closure device for closing said channel, said closure device having a rotatable part with an axis of rotation running transversely to said channel.

2. The closeable dispensing device according to claim 1., wherein:
said channel is made up of a plurality of channel portions which can be moved, at least in part, relative to one another;
in an open state of the closable dispensing device, said channel portions are disposed such that a through-channel is formed between the container and said outlet opening; and
in a closed state of the closable dispensing device, said channels portions are offset in relation to one another such that there is no through-channel formed between the container and said outlet opening.

3. The closeable dispensing device according to claim 2, wherein at least one of said channel portions is a closure portion running through said closure device, and said closure portion can be moved relative to other ones of said channel portions by virtue of said closure device being rotated.

4. The closeable dispensing device according to claim 1, wherein:
said body has a cutout formed therein; and
said closure device is a cylindrical element which is accessible from outside the closure dispensing device, and is inserted into said cutout and is rotated about its own longitudinal axis.

5. The closeable dispensing device according to claim 1, wherein said body has a pressure-equalizing opening formed therein through which a positive pressure or a negative pressure prevailing in the container can be dissipated by virtue of gas flowing out or in.

6. The closeable dispensing device according to claim 5, wherein said pressure-equalizing opening and said outlet opening are different openings.

7. The closeable dispensing device according to claim 5, wherein said pressure-equalizing opening is disposed such that an individual who is opening the closable dispensing device using his/her mouth, or who positions said outlet opening in his/her mouth as the closable dispensing device is being opened, cannot, or need not, breath in gases which pass out of said pressure-equalizing opening as the container is vented.

8. The closeable dispensing device according to claim 5, wherein the closable dispensing device is constructed such that, in a closed state of the closable dispensing device, there is no connection between said pressure-equalizing opening and the container.

9. The closeable dispensing device according to claim 5, wherein the closable dispensing device is constructed such that, during a movement of said closure device which has to be carried out in order to move the closable dispensing device from a closed state into an open state, first a connection is produced between said pressure-equalizing opening and the container, and only then is a connection produced between said outlet opening and the container.

10. The closeable dispensing device according to claim 5, wherein the closable dispensing device is constructed such that a connection between said pressure-equalizing opening and the container is broken if there is a connection between said outlet opening and the container.

11. The closeable dispensing device according to claim 1, wherein
said body has a closure-device accommodating cutout formed therein accommodating said closure device; and
said closure device and said closure-device accommodating cutout have a shape and a size selected such that it is not possible for the medium or any gas to pass through between said closure device and said closure-device accommodating cutout.

12. The closeable dispensing device according to claim 1, wherein said body has a part disposed between the container and said closure device which, at least in part, can be pressed elastically against said closure device by a positive pressure prevailing in the container.

13. The closeable dispensing device according to claim 11, wherein said closure device and said closure-device accommodating cutout have a cross section with an elliptical shape.

14. The closeable dispensing device according to claim 13, wherein:
said cross section of said closure-device accommodating cutout has a longitudinal axis;
said cross section of said closure device has a longitudinal axis, and when a position of said closure device closes said channel to said outlet opening, said longitudinal axis of said cross section of said closure device runs transversely to said longitudinal axis of said cross section of said closure-device accommodating cutout; and
when a position of said closure device does not close said channel to said outlet opening, said longitudinal axis of said cross section of said closure device runs along said longitudinal axis of said cross section of said closure-device accommodating cutout.

15. The closeable dispensing device according to claim 14, wherein said longitudinal axis of said cross section of said closure-device accommodating cutout runs transversely to said channel running to said outlet opening.

16. The closeable dispensing device according to claim 1, further comprising a lever disposed on said closure device, and by which said closure device can be rotated.

17. The closeable dispensing device according to claim 16, wherein in a closed state of the closable dispensing device, said lever projects upward in a direction of said outlet opening.

18. The closeable dispensing device according to claim 16, further comprising a closure cap closing said outlet opening, said closure cap disposed on said lever.

19. The closeable dispensing device according to claim 16, further comprising a hanging device disposed on said lever.

20. The closeable dispensing device according to claim 1, wherein the closable dispensing device is positioned on the container.

21. The closeable dispensing device according to claim 1, wherein the container is a drink bottle.
